(19) United States
(12) Patent Application Publication
(10) Pub. No.: US 2014/0158286 A1
(43) Pub. Date: Jun. 12, 2014

(54) METHOD FOR PRODUCING A CLADDING ELEMENT

(71) Applicant: INTERGLARION LIMITED, Engomi (CY)

(72) Inventor: Herbert RUHDORFER, Salzburg (AT)

(73) Assignee: INTERGLARION LIMITED, Engomi (CY)

(21) Appl. No.: 14/181,008

(22) Filed: Feb. 14, 2014

Related U.S. Application Data
(63) Continuation of application No. 12/160,686, filed on Jul. 11, 2008, now abandoned.

(30) Foreign Application Priority Data
Jan. 18, 2006 (DE) 10 2006 002 417.6

(51) Int. Cl. B44C 5/04; B32B 38/00; B32B 38/08

(52) U.S. Cl. CPC B44C 5/0492; B32B 38/08; B32B 38/0008; B32B 38/0012
USPC 156/153; 156/272.2; 156/280; 156/305; 156/326; 156/330.9; 156/60

(57) ABSTRACT

Method for producing a cladding element. The method includes applying a resin to a visible surface and to a contact surface of a wood material base board, applying at least one non-resin impregnated paper ply to the visible surface and at least one non-resin impregnated paper ply to the contact surface of the wood material base board, and pressing the at least one non-resin impregnated paper ply onto the resin applied visible surface and the at least one non-resin impregnated paper ply onto the resin applied contact surface. In this manner, the at least one paper ply on the visible surface and at least one paper ply on the contact surface are fully impregnated.

### CROSS-REFERENCE TO RELATED APPLICATIONS

The present application is a continuation of U.S. application Ser. No. 12/160,686, which is a U.S. National Stage of International Patent Application No. PCT/EP2007/000383 filed Jan. 17, 2007, and claims priority of German Patent Application No. 10 2006 002 417.6 filed Jan. 18, 2006. Moreover, the disclosures of U.S. application Ser. No. 12/160,686 and of International Patent Application No. PCT/EP2007/000383 are expressly incorporated by reference herein in their entireties.

### BACKGROUND OF THE EMBODIMENTS

1. Field of the Invention

The invention relates to a method for producing a cladding element, e.g., a flooring panel, a wall cladding element, a furniture face element or the like. The cladding element comprises a base board that is provided with a paper ply impregnated with resin on a surface, namely its visible surface or its contact surface opposite the visible surface.

2. Discussion of Background Information

Methods of this type are generally known in the prior art. A method of this type is explained in more detail below based on FIG. 2. However, it should be noted at this point that the materials utilized in performing method of the prior art described below do not differ from the materials utilized in performing the method according to the invention. All material data provided with reference to the known method as well as information on other parameters, such as layer thicknesses, grammatures and the like, therefore also continue to apply to the method according to the invention in the same manner.

The objective of the known method, the process steps of which are shown diagrammatically in FIG. 2, is the production of a cladding element 10, as shown in FIG. 3:

The cladding element 10 comprises a base board 12, which is preferably made of a wood material, e.g., a chipboard or a fiberboard, such as an MDF board (Medium Density Fiberboard) or an HDF board (High Density Fiberboard). If the cladding element is used as a flooring panel, it preferably has a thickness of approx. 5 mm to approx. 15 mm.

On its visible surface 12a, the base board 12 is provided with a decorative paper ply 14 that comprises at least one decorative paper layer 16. On its visible surface 14a, the decorative paper ply 14 or the uppermost decorative paper layer 16 thereof is printed with a desired pattern, e.g., a pattern imitating wood, stone, tiles or the like materials or products. The paper used for the decorative paper ply 14 usually has a grammature of a total of approx. 45 g/m² to approx. 160 g/m².

Decorative papers of this type are impregnated or soaked with impregnating resin on special impregnating machines, which is indicated by dots in FIG. 3. The quantity of impregnating resin applied is approx. 100% to approx. 140%, based on the base paper weight of the decorative paper ply 14.

In order to be able to prevent the occurrence of a deformation of the cladding element 10 due to the stresses stemming from the decorative paper ply 14, e.g., a bulging that destroys the desired completely flat and level structure of the cladding element, a counteracting paper ply 18 can optionally be arranged on the rear surface 12b of the base board 12 arranged opposite the visible surface 12a of the base board 12. The counteracting paper ply 18 is also impregnated with impregnating resin, as indicated by dots in FIG. 3. With respect to the base paper weight, i.e., the grammature of the paper used and the quantity of impregnating resin applied, the counteracting paper ply 18 essentially corresponds to the decorative paper ply 14 in order to ensure that both paper plies 14 and 18 exert stress influences on the base board 12 that essentially cancel one another out.

In order to protect the decorative paper ply 14 from abrasion, which is important not only when the cladding element 10 is used as a flooring panel, but also when it is used as a wall cladding element or furniture face element, a cover paper ply 20 (also known by the technical term overlay paper ply) can optionally also be applied onto the visible surface 14a of the decorative paper ply 14. Conventional cover papers or overlay papers preferably have a base paper weight of approx. 10 g/m² to approx. 80 g/m² and are transparent, particularly when they are impregnated with impregnating resin so as not to impede the view of the pattern of the decorative paper ply 14. The quantity of impregnating resin is between approx. 100% and approx. 300%, based on the base paper weight. To increase the abrasion resistance, a suitable additive, e.g., corundum, can also be added to the impregnating resin for the decorative paper ply 20, preferably in a quantity of approx. 5 g/m² to approx. 50 g/m².

Amino resins are preferably used as impregnating resins, e.g., urea-formaldehyde resins or melamine resins or mixtures of urea-formaldehyde resins and melamine resins, melamine resin preferably being used for impregnating the cover paper ply 20.

The known method for producing a cladding element 10 of this type, the individual process steps of which are shown diagrammatically in FIG. 2, is geared towards the cycle of production of the base board 12. All of the papers used in the layer structure of the cladding element 10 must therefore be held in stock in temporary storage, so that delays in production do not occur in the feed of the base boards 12.

For example, a decorative paper 14 printed with a desired pattern is provided in a step D. This decorative paper is impregnated with impregnating resin in a special impregnating machine in a step DI. The impregnating resin can thereby be applied to the decorative paper 14 in one or more steps, can penetrate therein and subsequently start to dry. The decorative paper 14 thus impregnated is then formatted in another step DF, i.e., cut to a size adjusted to the size of the fed base boards 12. The decorative paper 14 is now ready for further processing, in particular the hot pressing with the base board 12, and in a step DL is fed to a temporary storage 22, where it remains until further processing.

The counteracting paper 18 and the cover paper 20 are also analogously fed as base paper in steps R and O corresponding to the step D, impregnated with impregnating resin in steps RI and OI corresponding to the step DI, formatted in steps RF and OF corresponding to the step DF, and fed to temporary storages 24 and 26 corresponding to the temporary storage 22 in steps RL and OL corresponding to the step DL.

If a base board 12 is now conveyed in a step B, in steps DS, RS and OS respectively an impregnated and formatted decorative paper 14, counteracting paper 18 and cover paper 20 are taken from the respective temporary storages 22, 24 and 26 and stacked one above the other in the order described above with reference to FIG. 3. Subsequently, this stack is fed in a step HP to a hot press 28, in which the paper plies 14, 18 and 20 are pressed with the base board 12 to form the desired end product, namely the cladding element 10, using an increased pressure and an increased temperature.

Although the hot press 28 is indicated roughly diagrammatically in FIG. 2 in the form of two pressing plates, i.e., in the form of a press operating in a stationary manner, of course presses working continuously or quasi-continuously, e.g., feed-through presses, can also be used just as well.

The known method has the disadvantage that the papers impregnated with impregnating resin have only a time-limited storage stability. The impregnating resin must not be already thoroughly dried through before the hot pressing, but must be merely contact-dry such that the individual paper plies do not adhere to one another in the temporary storages, e.g., the temporary storage 22 for decorative paper 14. However the papers continue to dry, in particular the impregnating resin with which they are impregnated, in the temporary storage, so that if they are stored for too long they reach a degree of dryness that no longer permits a proper hot pressing. Impregnated papers stored for too long must therefore be removed and disposed of, which is a disadvantage not least because of the high material costs for the amino resins customarily used for impregnating.

### SUMMARY OF THE EMBODIMENTS

In view of the above-noted drawbacks of the known art, the present invention discloses a method of the type mentioned at the outset with which the waste quantities can be reduced, if not completely eliminated.

According to the invention a method of the type referenced at the outset provides that, in a first step the resin is applied to the surface of the base board, in which in a second step chronologically following the first step the paper ply is applied to the surface of the base board, and in which in a third step chronologically following the second step the base board provided on the surface with resin and the paper ply are pressed to one another.

According to the invention, the paper ply is therefore not already impregnated with resin before the temporary storage, instead it is not brought into contact with the resin applied to the base board and thereby soaked with the resin until the pressing of paper ply and base board. The actual impregnation of the paper ply therefore does not take place until the pressing. The paper can therefore be stored temporarily as base paper, so that it is no longer subject to any restrictions in terms of time with respect to the temporary storage period. Base paper in the case of the decorative paper ply thereby also means paper already printed with a pattern. Since the resin is applied to the base board according to the invention, it is also ensured that resin is used only when a base board is actually available for further processing. The resin can be applied onto the visible surface and/or the contact surface, e.g., with a weight per unit area of between approx. 50 g/m² and approx. 200 g/m². The application can be carried out, e.g., by a roller coating apparatus known per se.

In a further development of the invention, a hardener necessary for hardening the resin can be applied to the surface of the base board jointly with the resin in the first step, preferably as a resin-hardener mixture. However, alternatively it is also possible and even advantageous if the hardener and the resin are applied to the surface of the base board in two steps separated from one another. The hardener is preferably applied to the surface of the base board separately from the resin in a fourth step preceding the first step. The latter method variant means that the problem can also be avoided that once a resin is mixed with the hardener it must be processed within a predetermined processing time, also known as pot life. This leads to a further reduction of the risk of material waste and thus helps to reduce the production costs of the cladding elements.

For example, an ammonium chloride solution or an ammonium sulfate solution or a maleic anhydride solution can be used as a hardener.

As is known per se from the prior art, with the method according to the invention the paper ply can also be formatted in a fifth step chronologically preceding the second step, the difference from the method of the prior art being merely that the paper ply is formatted as a base paper ply.

Depending on the desired structure of the cladding element to be produced, only one decorative paper ply can be applied to the visible surface of the base board according to the method according to the invention. With respect to the deformation problem explained at the outset, furthermore a counteracting paper ply can optionally be provided on the contact surface of the base board.

If the base board is provided on its visible surface as well as on its contact surface in each case with a paper ply, namely a decorative paper ply on the visible surface and a counteracting paper ply on the contact surface, it is advantageous in further development of the invention, since it saves time, if the first steps of applying the respective resin onto the respective surface, and/or the second steps of the application of the respective paper ply onto the respective surface provided with resin, and/or the third steps of the pressing of the respective paper ply with the base board, are carried out essentially simultaneously.

Moreover, with respect to the wear or abrasion problems discussed at the outset, it is optionally further possible to provide a cover paper ply over the decorative paper ply on the visible surface of the base board. In this case, the resin quantity applied in the first step to the visible surface of the base board can preferably be measured such that it is also sufficient for soaking or impregnating the decorative paper ply as well as the cover paper ply during the pressing of the paper plies with the base board in the third process step.

Furthermore, when the base board is provided on its visible surface with a decorative paper ply as well as with a cover paper ply, the second steps of applying the two paper plies onto the visible surface of the base board provided with resin and/or the third steps of pressing the two paper plies with the base board can be carried out essentially simultaneously.

As already mentioned at the outset, the resin can be an amino resin, preferably a urea-formaldehyde resin or a melamine resin or a urea-formaldehyde melamine resin mixture. Furthermore, the resin, in particular the resin used for impregnating the paper plies provided on the visible side, can contain at least one substance that increases abrasion resistance, e.g., corundum.

It should be added that each of the paper plies, i.e., the decorative paper ply and/or the counteracting paper ply and/or the cover paper ply, can be formed from a plurality of paper layers.

If desired, the cladding element thus produced can be fed to a surface finishing. To this end the surface of the decorative paper ply or, if necessary, the surface of the cover paper ply can first be subjected to a surface treatment. This surface treatment can comprise a chemical treatment, e.g., the application of an adhesion promoter and/or a fluorination, and/or a mechanical treatment, e.g., the grinding of the surface, and/or an electrical treatment, e.g., a corona treatment and/or a plasma treatment. Subsequently, a varnish layer can be applied and be dried on the surface thus prepared. If desired, this varnish application can also be repeated several times, if necessary with renewed prior surface treatment of the varnish layer last applied.

The product “Hydrohaftgrund E643” sold by Henelit, Villach, Austria, or an organofunctional silane, for example, can be used as an adhesion promoter. Organo functional silanes are hybrid compounds with a reactive organic group and an inorganic alkyl silicate, in which the organic functional group as well as the inorganic hydrolyzable alkoxy group respectively can be coordinated with the impregnating resin or amino resin used and the varnish used, in order to achieve good adhesion-promoting properties.

During the fluorination, the resin-impregnated decorative paper ply pressed with the base board can be treated in a vacuum reactor. After the evacuation and inertization of the reactor, i.e., the removal of any impurities still adhering or bonded to reactor surfaces, e.g., by rinsing with inert gas, heating the reactor or the like, fluorine and inert gas are added in a targeted manner. A variable concentration profile of the fluorine mixture at ambient temperature can be used during the treatment time in order to achieve optimal results. Subsequently the reactor is evacuated, rinsed and the decorative paper ply can be removed. This so-called offline fluorination can be integrated into any production method as an aftertreatment method. Through the fluorination the surface tension and thus the wetting of the surface by a varnish are improved. Moreover, a polar surface is achieved, which leads to a better adhesion of a varnish layer.

In a corona treatment, air located in the space between two electrodes is ionized. Depending on their kinetic energy, these ions then penetrate into the surface of the decorative paper ply to be treated located between the electrodes, namely, e.g., up to 10 μm deep. The physical and chemical changes caused thereby on the surface of the decorative paper ply to be treated cannot yet be definitively explained. However, it is assumed that oxidation processes on the surface play a role and physical and chemical changes of the surface take place caused by the bombardment with accelerated ions and electrons. However, it is a scientifically proven fact that a corona treatment causes an improved adhesion of the surface so that, as desired, a varnish coat applied adheres better to a decorative paper ply thus treated.

Similar effects are also obtained with the plasma treatment. Here it is not the direct electric arc that forms at the electrodes acted on with high voltage that is used to treat the surface; instead a reactive potential-free particle jet of ionized air is generated by charge separation and directed at the surface of the decorative paper ply to be treated.

Any desired surface reflection property from matt to high-gloss can be easily achieved through corresponding polishing of the aftertreated, in particular varnished, surface. In particular with a high-gloss polished surface, a cladding element, the decorative paper ply of which is printed with a wood pattern, is virtually indistinguishable from genuine wood.

Embodiments are directed to a method for producing a cladding element. The method includes applying a resin to a visible surface and to a contact surface of a wood material base board, applying at least one non-resin impregnated paper ply to the visible surface and at least one non-resin impregnated paper ply to the contact surface of the wood material base board, and pressing the at least one non-resin impregnated paper ply onto the resin applied visible surface and the at least one non-resin impregnated paper ply onto the resin applied contact surface. In this way, the at least one paper ply on the visible surface and at least one paper ply on the contact surface are fully impregnated.

According to embodiments, the cladding element can include one of a flooring panel, a wall cladding element, and a furniture face element.

In accordance with other embodiments of the invention, the pressing of the wood material base board with the applied resin and the paper plies may occur essentially simultaneously.

In further embodiments, the method can include applying a hardener to harden the resin to the visible surface and to the contact surface of the wood material base board. The hardener can be applied jointly with the resin.

According to still other embodiments, the resin can include a mixture of resin and a hardener. The may be applied separately from the resin.

In accordance with other embodiments of the invention, the method can include formatting the at least one non-resin impregnated paper ply before it is applied to the visible surface of the wood material base board.

In embodiments, the applying of resin to the visible surface and to the contact surface of the wood material base board can be performed simultaneously.

In further embodiments, the applying of the at least one paper ply to the visible surface and to the contact surface of the wood material base board can be performed simultaneously.

In other embodiments of the invention, the at least one paper ply applied to the visible surface of the wood material base board may include a decorative paper ply and a cover paper ply. Further, the applying of the resin to the visible surface and to contact surface can include applying an amount of resin to the visible surface based upon the decorative paper ply and a cover paper ply to be applied to the visible surface. The applying the decorative and cover paper plies on the visible surface of the base board can be performed simultaneously. Moreover, the pressing of the decorative paper ply and a cover paper ply with the wood material base board may be performed simultaneously.

In other embodiments, the resin may include an amino resin. The amino resin can include one of a urea-formaldehyde resin, a melamine resin, or a urea-formaldehyde melamine resin mixture.

Further, the resin can contain at least one substance that increases abrasion resistance, and the resin can contain corundum.

According to still further embodiments of the invention, the at least one paper ply applied to the visible surface of the wood material base board can include a decorative paper ply and a cover paper ply, and the method can further include surface treating at least one of the decorative paper ply and the cover paper ply, and applying at least one varnish layer on the treated surface. The surface treating may include a chemical treatment. Further, the surface treating can include the applying of an adhesion promoter. The adhesion promoter may include at least one of organofunctional silane and a fluorination. The surface treating can include an electrical treatment. Further, the surface treating can include one of a corona treatment or a plasma treatment. Still further, the surface treating may include a mechanical treatment. The surface treating can include a grinding of the surface. Moreover, the varnish may contain at least one substance that increases abrasion resistance, and the resin may contain corundum.

In accordance with still yet other embodiments of the present invention, the applying of the resin, the applying of the at least one paper ply to the visible surface and to the contact surface of the wood material base board, and the pressing of the wood material base board can be performed in chronological succession.

### BRIEF DESCRIPTION OF THE DRAWINGS

The invention is described in more detail below with reference to the attached drawing based on an exemplary embodiment. It shows:

FIG. 1: A diagrammatic flow chart of an embodiment variant of the method according to the invention;

FIG. 2: A view similar to FIG. 1 of a production method according to the prior art; and

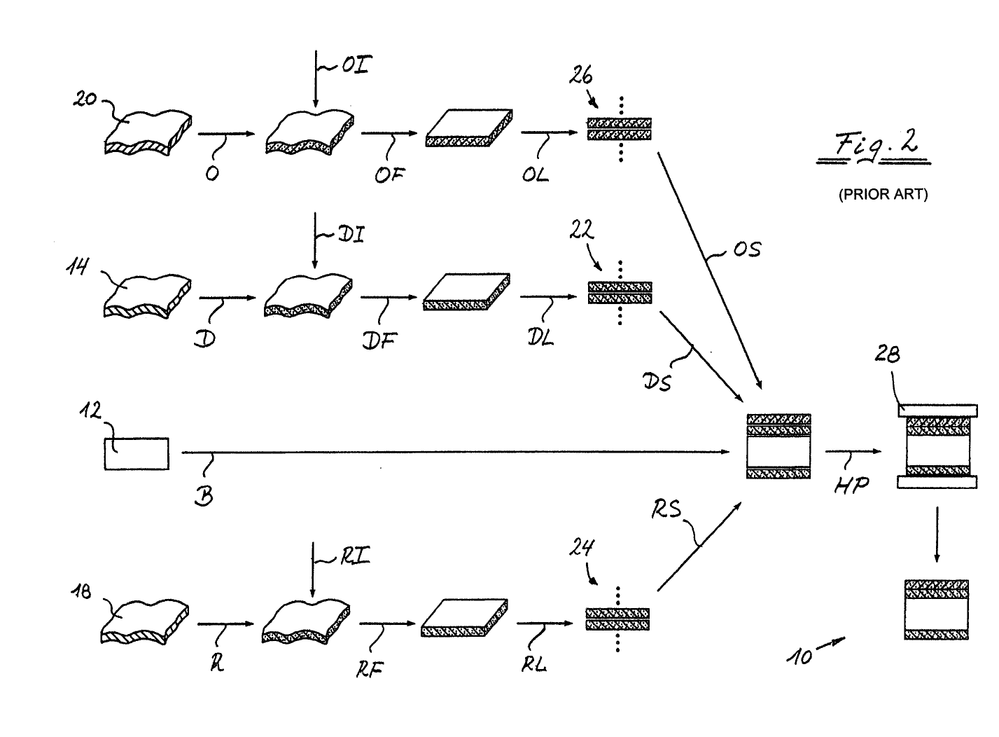

FIG. 3: A diagrammatic representation to explain the layer structure of a cladding element to be produced according to the method according to the invention.

### DETAILED DESCRIPTION OF THE EMBODIMENTS

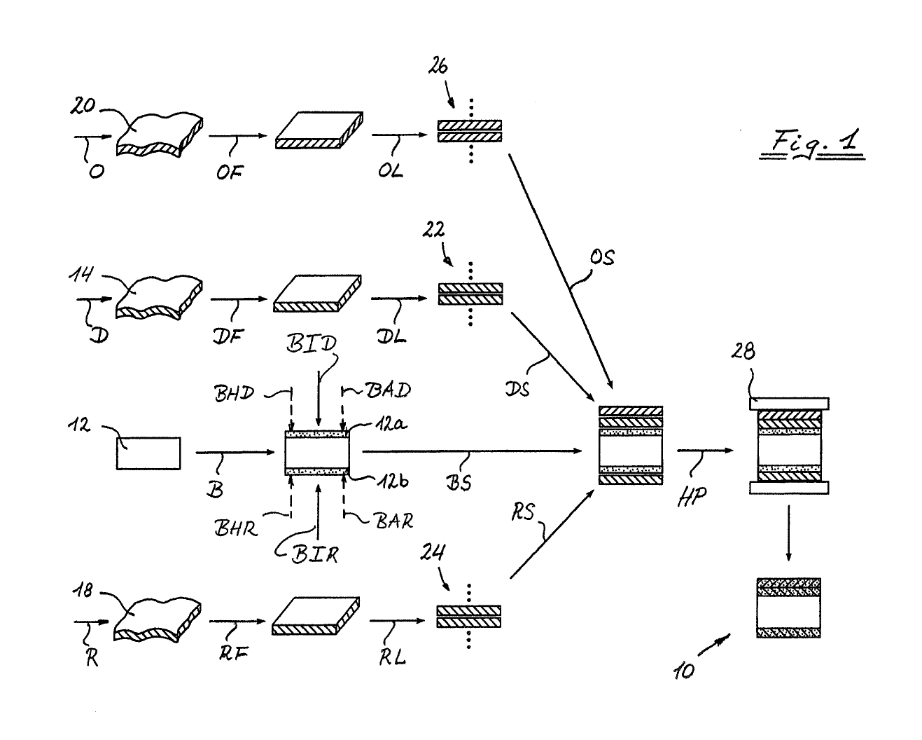

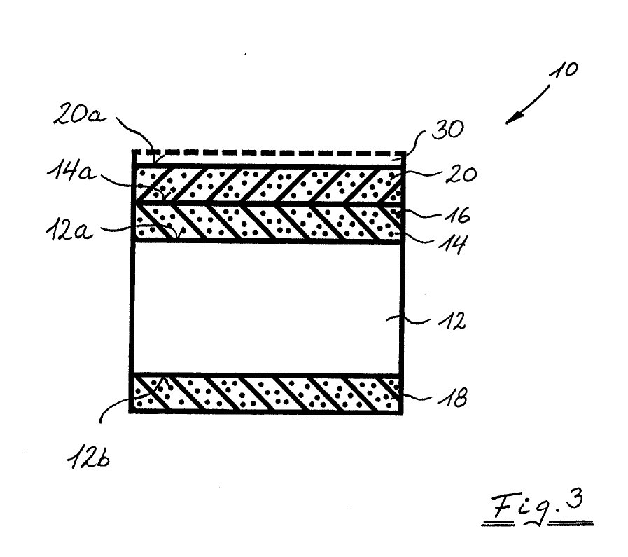

A method according to the invention for producing a cladding element 10 is explained below in more detail with reference to FIG. 1, which cladding element has the structure already explained at the outset with reference to FIG. 3, i.e., in particular is provided on its visible surface 12a with a decorative paper ply 14 as well as with a cover paper ply 20 and on its contact surface 12b with a counteracting paper ply 18.

As shown in FIG. 1, the decorative paper ply 14 is provided as base paper in a step D and is formatted in a size matching the dimensions of the base board 12 in a step DF. In a step DL the formatted decorative paper ply 14 is then fed to a temporary storage 22 in which it is stored temporarily until further processing.

Analogously, counteracting paper plies 18 or cover paper plies 20 provided as base paper in steps R or O corresponding to step D are formatted in steps RF or OF corresponding to the step DF and fed to a temporary storage 24 or 26 in steps RL or OL corresponding to the step DL. In contrast to the prior art method explained at the outset, the papers stored temporarily in the temporary storages 22, 24 and 26 are therefore not impregnated with resin. This completely eliminates the problem occurring with the known method that maximum temporary storage times stemming from the drying time of the resin must be observed.

With the method according to the invention a base board 12 provided in a step B is provided in a step BID on its visible surface 12a with a layer of impregnating resin, more precisely, with a layer of an impregnating resin-hardener mixture. If necessary, the base board 12 can also be provided with a corresponding layer on the rear side i.e., on its contact surface 12b, in a step BIR.

Alternatively, the steps BID and BIR respectively can also be divided into two steps BHD and BAD or BHR and BAR occurring at time intervals, which is indicated by broken-line arrows in FIG. 1. In the steps BHD and BHR first a hardener necessary to harden the impregnating resin is thereby applied to the visible surface 12a or the rear surface 12b of the base board 12, and subsequently the actual application of the impregnating resin takes place in the steps BAD and BAR. The latter method variant is advantageous with respect to the problem of the pot life of an impregnating resin-hardener mixture.

The steps BID and BIR or the steps BHD and BHR and the steps BAD and BAR can preferably be undertaken essentially at the same time.

The base board 12 thus coated with resin on its two surfaces 12a, 12b is fed in a step BS to a stacking process, in which a decorative paper ply 14 fed in a step DS and optionally a cover paper ply 20 fed in a step OS is applied onto the visible surface 12a of the base board 12. Optionally, a counteracting paper ply 18 fed in a feed step RS is applied onto the contact surface 12b of the base board 12. In a step HP the stack thus formed is fed to a hot press 28 in which the different paper plies are pressed with the base board 12 under increased pressure and increased temperature. In particular during this pressing process the resin applied to the base board 12 penetrates into the different paper plies and soaks or impregnates them. A cladding element 10 with the layer structure shown in FIG. 3 is thus obtained.

Subsequently, the cladding element 10 thus produced can, if desired, also be subjected to a surface finishing. To this end the surface 14a of the decorative paper ply or optionally the surface 20a of the cover paper ply 20 is first subjected to a surface treatment. This surface treatment can comprise a chemical treatment, e.g., the application of an adhesion promoter and/or a fluorination, and/or a mechanical treatment, e.g., the grinding of the surface, and/or an electrical treatment, e.g., a corona treatment, and/or a plasma treatment. Subsequently, a varnish layer 30 can be applied onto the surface thus prepared and dried, which is indicated in FIG. 3 merely by broken lines. If desired, this varnish application can also be repeated several times, if necessary with prior surface treatment of the varnish layer last applied.

According to an exemplary embodiment, the surface treatment first comprises the application of an adhesion promoter, e.g., the product “Hydrohaftgrund E643” sold by Henelit, Villach, Austria, namely in an amount of between approx. 5 g/m² and approx. 30 g/m². This adhesion promoter is subsequently hardened by UV radiation. To further improve the adhesive strength of the following varnish application, the surface can then also be ground, if desired. The varnish can be applied as a roller varnish or as a spray varnish. For example, a polyurethane varnish or a UV varnish can be used as a varnish, such as the “UV Hydro brillant” varnish sold by Henelit, Villach, Austria. The varnish application can be carried out in an amount of between approx. 15 g/m² and approx. 30 g/m² for the varnish base layer and between approx. 5 g/m² and approx. 10 g/m² for further varnish layers.

To increase the abrasion resistance of the varnish layer, a suitable additive can be added to the varnish, e.g., corundum, preferably in an amount of approx. 5 g/m² to approx. 50 g/m². If the abrasion resistance of the varnish layer thus applied is sufficient, the use of a cover paper can be omitted. Since the varnish layer does not lead to any additional stress in the layer structure applied onto the visible surface 12a of the base board 12, no special precautions need to be taken on the rear surface 12b of the base board 12 in the counteracting paper layer 18.

What is claimed:

1. A method for producing a cladding element, the method comprising:
applying a resin to a visible surface and to a contact surface of a wood material base board;
applying at least one non-resin impregnated paper ply to the visible surface and at least one non-resin impregnated paper ply to the contact surface of the wood material base board; and
pressing the at least one non-resin impregnated paper ply onto the resin applied visible surface and the at least one non-resin impregnated paper ply onto the resin applied contact surface, whereby the at least one paper ply on the visible surface and at least one paper ply on the contact surface are fully impregnated.

2. The method in accordance with claim 1, wherein the cladding element comprises one of a flooring panel, a wall cladding element, and a furniture face element.

3. The method in accordance with claim 1, wherein the pressing of the wood material base board with the applied resin and the paper plies occurs essentially simultaneously.

4. The method in accordance with claim 1, further comprising applying a hardener to harden the resin to the visible surface and to the contact surface of the wood material base board.

5. The method in accordance with claim 4, wherein the hardener is applied jointly with the resin.

6. The method in accordance with claim 1, wherein the resin comprises a mixture of resin and a hardener.

7. The method in accordance with claim 6, wherein the hardener is applied separately from the resin.

8. The method in accordance with claim 1, further comprising formatting the at least one non-resin impregnated paper ply before it is applied to the visible surface of the wood material base board.

9. The method in accordance with claim 1, wherein the applying of resin to the visible surface and to the contact surface of the wood material base board are performed simultaneously.

10. The method in accordance with claim 1, wherein the applying of the at least one paper ply to the visible surface and to the contact surface of the wood material base board are performed simultaneously.

11. The method in accordance with claim 1, wherein the at least one paper ply applied to the visible surface of the wood material base board comprises a decorative paper ply and a cover paper ply, and wherein the applying of the resin to the visible surface and to contact surface comprises applying an amount of resin to the visible surface based upon the decorative paper ply and a cover paper ply to be applied to the visible surface.

12. The method in accordance with claim 11, wherein the applying the decorative and cover paper plies on the visible surface of the base board are performed simultaneously.

13. The method in accordance with claim 11, wherein the pressing of the decorative paper ply and a cover paper ply with the wood material base board are performed simultaneously.

14. The method in accordance with claim 1, wherein the resin comprises an amino resin.

15. The method in accordance with claim 14, wherein the amino resin comprises one of a urea-formaldehyde resin, a melamine resin, or a urea-formaldehyde melamine resin mixture.

16. The method in accordance with claim 1, wherein the resin contains at least one substance that increases abrasion resistance.

17. The method in accordance with claim 16, wherein the resin contains corundum.

18. The method in accordance with claim 1, wherein the at least one paper ply applied to the visible surface of the wood material base board comprises a decorative paper ply and a cover paper ply, and the method further comprises surface treating at least one of the decorative paper ply and the cover paper ply; and
applying at least one varnish layer on the treated surface.

19. The method in accordance with claim 18, wherein the surface treating comprises a chemical treatment.

20. The method in accordance with claim 18, wherein the surface treating comprises the applying of an adhesion promoter.

21. The method in accordance with claim 20, wherein the adhesion promoter comprises at least one of organofunctional silane and a fluorination.

22. The method in accordance with claim 18, wherein the surface treating comprises an electrical treatment.

23. The method in accordance with claim 18, wherein the surface treating comprises one of a corona treatment or a plasma treatment.

24. The method in accordance with claim 18, wherein the surface treating comprises a mechanical treatment.

25. The method in accordance with claim 18, wherein the surface treating comprises a grinding of the surface.

26. The method in accordance with claim 18, wherein the varnish contains at least one substance that increases abrasion resistance.

27. The method in accordance with claim 26, wherein the resin contains corundum.

28. The method in accordance with claim 1, wherein the applying of the resin; the applying of the at least one paper ply to the visible surface and to the contact surface of the wood material base board; and the pressing of the wood material base board are performed in chronological succession.
